(19) United States
(12) Patent Application Publication
(10) Pub. No.: US 2011/0181057 A1
(43) Pub. Date: Jul. 28, 2011

(54) DOOR HANDLE

(76) Inventor: Moshe Danino, Tel Aviv (IL)

(21) Appl. No.: 13/119,128

(22) PCT Filed: Sep. 15, 2009
(86) PCT No.: PCT/IL2009/000902

§ 371 Date: Mar. 15, 2011

Related U.S. Application Data
(60) Provisional application No. 61/097,264, filed on Sep. 16, 2008.

(51) Int. Cl. E05B 3/00

(52) U.S. Cl. 292/336.3

(57) ABSTRACT

A door-handle assembly including a spindle (20), having a substantially square cross section. The spindle is operatively attached to a cam mechanism of the door. The door-handle assembly further includes a handle having a static part (120) and a pivotal part (110), a base part (140) and a spindle housing (112). The base part is securely attached to the door. The static part is securely attached to the door. The pivotal part is securely attached to the spindle housing and pivotally attached to the base. In idle state, the pivotal part is supported by and aligned with the static part, such that the pivotal part is haptically and visually flush with the static part. Preferably, a hollow cavity, having an eight-points star form, is formed inside the handle spindle. The hollow cavity enables mounting the handle on the spindle in 8 directional orientations.

### CROSS REFERENCE TO RELATED APPLICATIONS

This application claims the benefit under 35 USC 119(e) from US provisional application 61/097,264 filed Sep. 16, 2008, the disclosure of which is included herein by reference.

### FIELD OF THE INVENTION

This invention relates to door handles and more particularly the present invention relates to door handles having a static part and a pivotal part, whereas the static part serves as a stopper for the pivotal part. Preferably, when the handle is in idle state, the static part and the pivotal part seem to be, haptically and visually, made of one piece. The hollow cavity formed inside the handle to fittingly house the spindle, has a symmetric eight-points star form, rather than a square form, thereby enables mounting the handle on a standard spindle in eight directional orientations, rather than just four.

### BACKGROUND OF THE INVENTION AND PRIOR ART

Commonly used door handles, are typically attached to a simple mechanism with an axle (referred to as “spindle”) that has at least one flat side, which is passed through the door latch, leaving some length exposed on each side of the door to which the handles are attached.

Reference is made to FIG. 1 (prior art), which illustrates common handle door 10, being part of a lock assembly 50. FIG. 2 (prior art) illustrates an exploded view of lock assembly 50. Typically, lock assembly 50 includes handle door 10, lock assembly body 30, spindle 20, fitted hollow channel 34 formed inside spindle shaft 35 of lock assembly body 30, which inner form of hollow channel 34 fits the shape and size of the surface outer shape of spindle 20, lock unit 32, handle cam 36 and lock cam 38. Pivotal motion of spindle shaft 35 is operatively engaged with handle cam 36, to move handle cam 36 in or out of lock assembly body 30.

Handles 10 are attached on both ends of spindle 20 by screwing or sliding them directly onto spindle 20, and then securing one or more retaining screws 12 through each handle perpendicular to a flat surface of spindle 20. The cross section of a prior art spindle 20 has a square form. FIG. 3 (prior art) shows cross-section AA′ of spindle 20 of lock assembly 50, which is typically square.

When handle 10 is pivotally turned down, spindle 20, being securely attached to handle 10, is rotated with handle 10 and thereby, cam 36, being operatively attached to spindle 20, moves out of a corresponding door latch, thereby enable the opening of the door.

Spindle 20 is typically an elongated rod having a substantially square cross section. Since the cross section of spindle 20 is substantially square, and since fitted hollow channel 34 has also a substantially square cross section, the orientation of handle 10 is typically either horizontal (two possibilities) or vertical (two possibilities).

There is a need for and it would be advantageous to enable mounting handle 10 in orientations other than horizontal or vertical.

Some prior art doors include one or more static door handles, that are not operatively attached to handle cam 36, and thereby cannot open handle cam 36. Such handles prevent unwanted persons from opening the door. The doors are opened by the lock key or by a hidden handle/switch.

There is a need for and it would be advantageous to have a door handle that is built and designed to look like a static door handle, but a portion of the door handle is pivotal and is operatively attached to handle cam 36.

### BRIEF SUMMARY OF THE INVENTION

By way of introduction, the principal intentions of the present invention include proving a door handle having a static part and a pivotal part, whereas the static part serves as a stopper for the pivotal part. Preferably, when the handle is in idle state, the static part and the pivotal part seem to be, haptically and visually, made of one piece. Furthermore, the hollow cavity formed inside the handle, which fittingly houses the spindle, has a symmetric eight-points star form, which enables mounting the handle on a standard spindle in 8 directional orientations, rather than just four.

It should be note that door handle assembly of the present invention is typically used on a door, but can also be used on gates, windows and the like. Hence, the term “door” as used herein refers to refers to all barriers made of wood or other material, which barriers can be opened and closed.

According to the teachings of the present invention, there is provided a door-handle assembly for a door, including a spindle operatively attached to a cam mechanism of a lock mechanism of the door, the spindle having a rotating axis and a substantially square cross section, the door-handle assembly including a handle having a static part and a pivotal part, a base part, at least one static mounting part and a spindle housing having a first end and an open end. The base part is securely attached to the door. The static part is securely attached to the door by the static mounting part. The pivotal part is securely attached to the first end of the spindle housing, and the open end of the spindle housing is pivotally attached to the base. When assembled and in idle state, the pivotal part is aligned with the static part. Preferable, the pivotal part, being in idle state, is supported by the static part. Optionally, the pivotal part is aligned with the static part such that the pivotal part is haptically and visually flush with the static part.

Preferably, the static part is securely attached to an elongated variation of the base part by the static mounting part.

The spindle housing is pivotally attached to the base part by a spindle attachment assembly. The spindle attachment assembly includes a bias and a limiter, wherein the limiter is securely attached onto a fitted groove disposed at the open end of the spindle housing, whereby the spindle housing is pivotally attached to the base part.

Typically, the static part serves as a stopper of the pivotal part, resisting the bias, the bias being a returning spring or any other bias. In variations of the present invention, a conventional stopper of the lock mechanism of the door resists the bias.

The spindle is operatively attached to the cam mechanism through a hollow channel formed in the cam mechanism, wherein the hollow channel has a substantially square shape fitted to the substantially square shape of the spindle. A hollow cavity is formed inside the spindle housing, substantially symmetric about the rotating axis, to fittingly attach a first end section of the spindle.

In variations of the present invention, the hollow cavity formed inside the spindle housing has an eight-point star cross section. In other variations of the present invention, the hollow cavity formed inside the spindle housing has a twelve-point star cross section.

In variations of the present invention, a supporting surface of the static part is a slanted surface disposed at a first end of the static part. The pivotal part has a slanted surface disposed at a first end of the pivotal part, wherein the first end of the static part faces the first end of the pivotal part. When the pivotal part is reaching the idle state, the slanted surface of the static part is substantially tangential to the slanted surface of the pivotal part.

In variations of the present invention, the spindle is operatively attached to the cam mechanism through a hollow channel formed in the cam mechanism, wherein the hollow channel has a substantially symmetrical star shape. The star shaped hollow channel has multiple points P, P being divisible in four (4), such that R=P/4, where R is the number of different orientations, exclusive of symmetrical orientations, in which the spindle can be securely inserted into the hollow channel. For example, if the hollow channel has 4 points, the spindle (having a square cross section) has just one effective orientation, as in all four positions the handle is assembled in the same orientation. If the hollow channel has 8 points, the spindle has just two effective orientation, one being 45° from the other.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 (prior art) illustrates common a handle door, being part of a lock assembly;

FIG. 2 FIG. 2 (prior art) illustrates an exploded view of the lock assembly shown FIG. 1;

FIG. 3 (prior art) shows cross-section AA′ of the spindle of the lock assembly shown FIG. 1;

FIG. 4 is a perspective view illustration of a door handle assembly, according to variations of the present invention;

FIG. 5 is a side view of the door handle assembly shown in FIG. 4;

FIG. 6 is a perspective exploded view of the door handle assembly shown in FIG. 4;

FIG. 6a is a perspective exploded view of the door handle, according to variations of the present invention;

FIG. 7 is a top view of the door handle assembly shown in FIG. 4, in a closed, idle state;

FIG. 8 is a top view of the door handle assembly shown in FIG. 4, in an opened state;

FIG. 9 is a top view of the door handle assembly shown in FIG. 4, mounted in a 45° angle orientation;

FIG. 10 is a bottom view of the door handle assembly shown in FIG. 4;

FIG. 11 is an enlarged, bottom perspective view of the door handle assembly shown in FIG. 4, showing the end portion of the mechanism for attaching to the spindle;

FIG. 12 illustrates an exploded view of a handle door assembly, according to variations of the present invention; and

FIG. 13 illustrates an exploded view of a handle door assembly, according to other variations of the present invention.

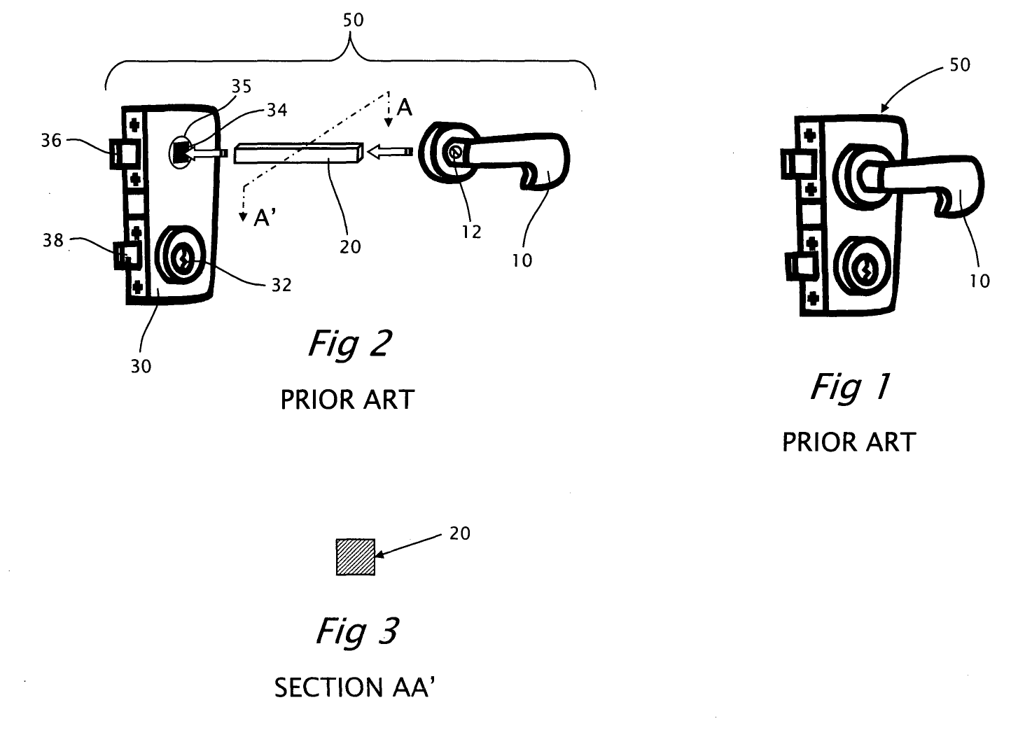

### DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The methods and examples provided herein are illustrative only and not intended to be limiting.

By way of introduction, the principal intentions of the present invention include proving a door handle assembly having a static part and a pivotal part, whereas preferably, the static part serves as a stopper for the pivotal part. Preferably, when the handle is in idle state, the static part and the pivotal part seem to be, haptically and visually, made of one piece. Furthermore, the hollow cavity formed inside the handle and which fittingly houses the spindle, has a symmetric eight-points star form, which enables mounting the handle on a standard spindle in 8 directional orientations, rather than just four directional orientations.

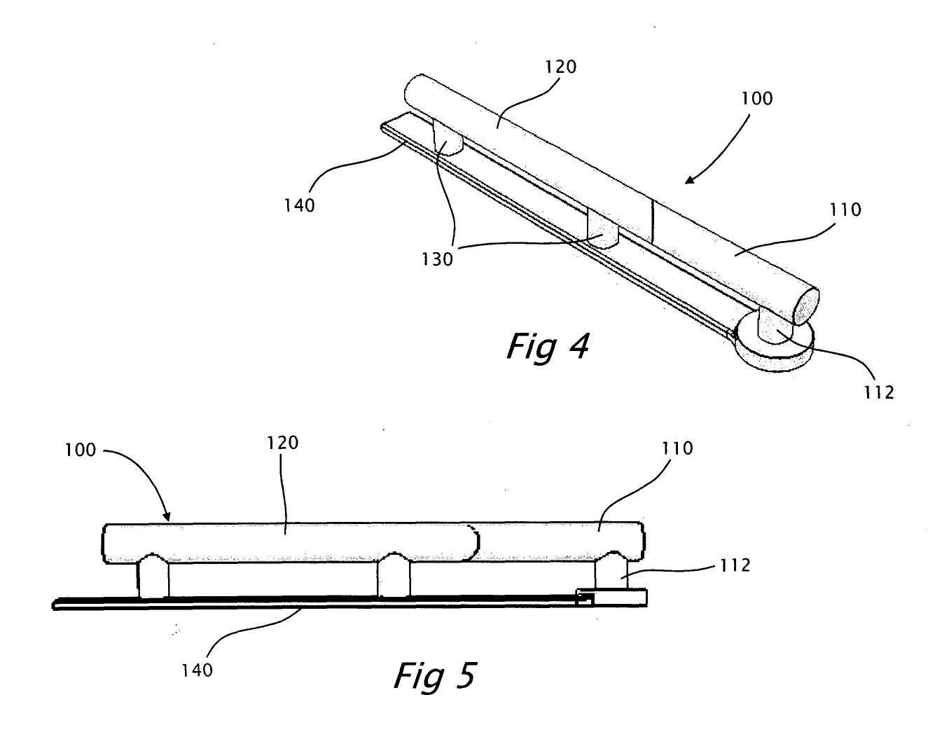

Reference is now made to the drawings. FIG. 4 is a perspective view illustration of door handle assembly 100, according to variations of the present invention, and FIG. 5 is a side view of door handle assembly 100. Handle assembly 100 includes static part 120, pivotal part 110, base part 140 one or more static mounting parts 130 and spindle housing 112. Optionally when handle 100 is in idle state, pivotal part 110 is supported by static part 120, preferably, such that pivotal part 110 is haptically and visually flush with static part 120.

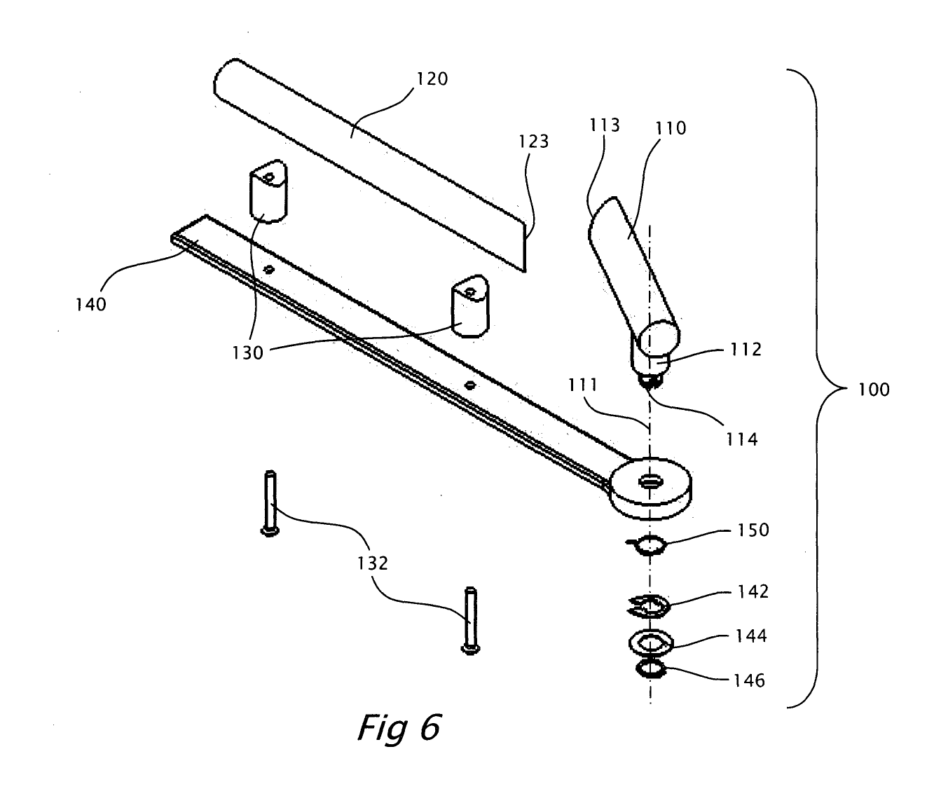

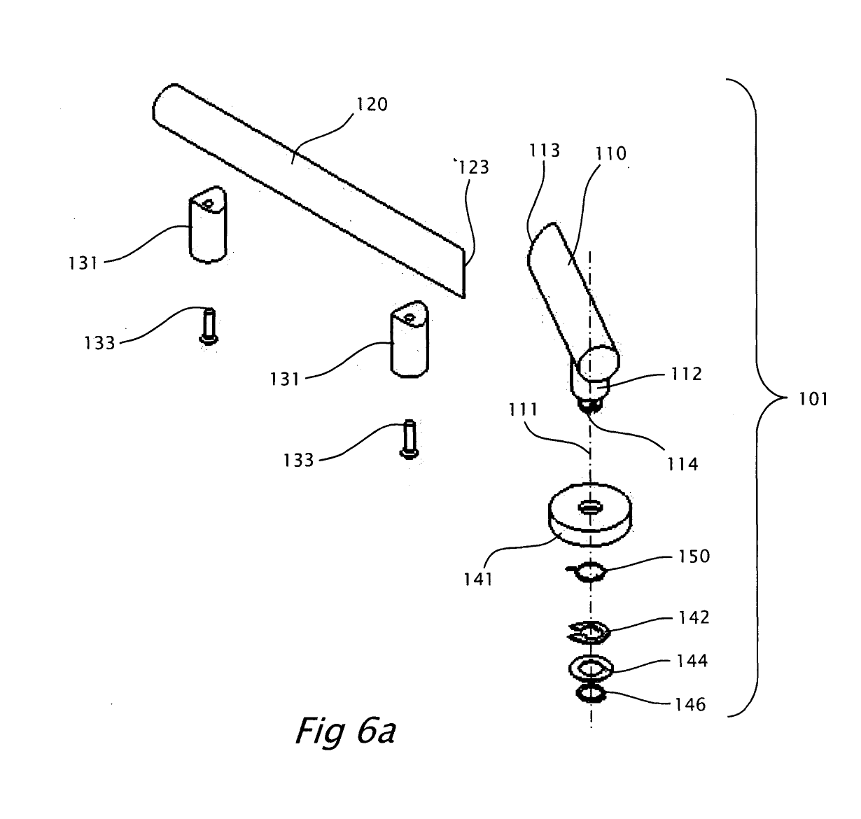

FIG. 6 is a perspective exploded view of door handle assembly 100. Static part 120 is affixed to a first end of mounting parts 130 and the second end of mounting parts 130 is affixed to base part 140, which base part 140 is affixed to the door, for example with bolts 132. The above combination of static part 120, mounting parts 130 and base part 140 serve as a static door handle, herein referred to as the static portion of handle assembly 100.

Pivotal part 110 includes spindle housing 112 having a first end and an open end. Spindle housing 112 is affixed to pivotal part 110 at the first end of spindle housing 112. Spindle housing 112 is also attached to base part 140 at the open end, such that pivotal part 110 can be turned about axis 111, which coincides with the turning axis of spindle 20. For example, spindle housing 112 is pivotally attached to base part 140 with returning spring 150, limiter 142 and washers 144 and 146, wherein limiter 142 is securely attached onto a fitted groove 114 at the open end of spindle housing 112.

Reference is also made to FIG. 6a, which is a perspective exploded view of door handle assembly 101, according to variations of the present invention. Pivotal part 110 includes spindle housing 112 which is attached to base part 141 such that pivotal part 110 can be turned about axis 111, which coincides with the turning axis of spindle 20. For example, spindle housing 112 is pivotally attached to base part 141 with returning spring 150, limiter 142 and washers 144 and 146, wherein limiter 142 is securely attached onto a fitted groove 114 at the open end of spindle housing 112. It should be noted that base part 141 is substantially smaller than base 140. Mounting parts 131 are typically affixed to the door by a conventional attaching mechanism. Mounting parts 131 are affixed to static part 120, for example and with no limitation, by bolts 133.

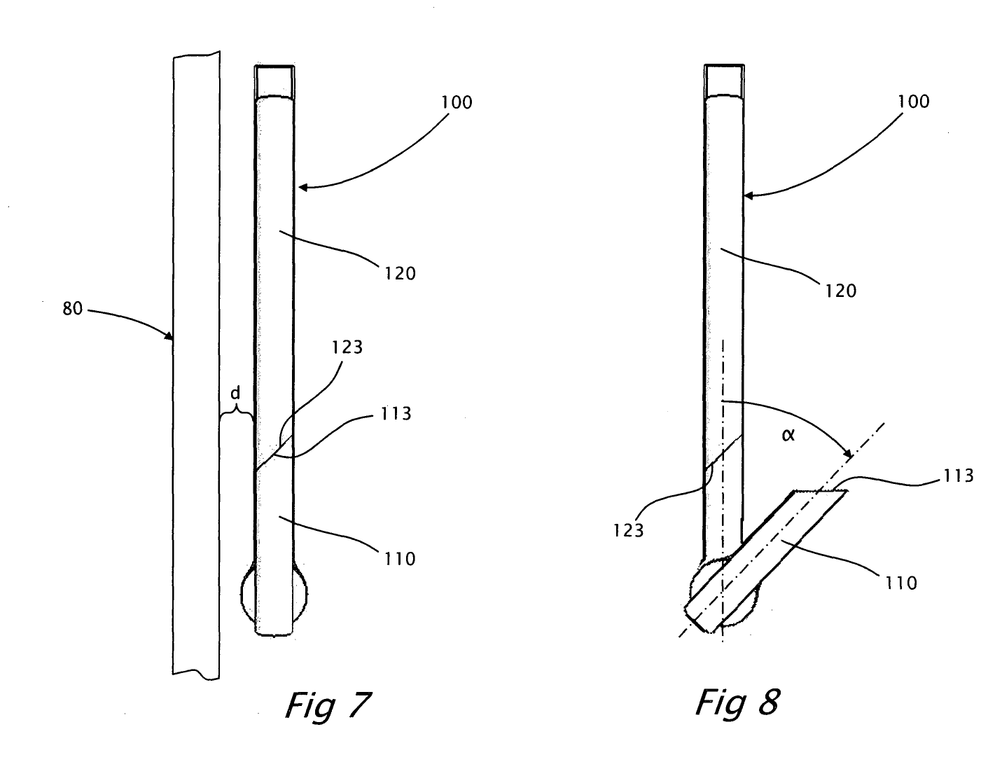

An aspect of the present invention is to build static part 120 and pivotal part 110 such that when handle 100 is in idle state, pivotal part 110, being in idle state, is preferably supported by static part 120 such that pivotal part 110 is haptically and visually flush with static part 120. To obtain the flush effect, static part 120 has slanted surface 123 disposed at the end adjacent to pivotal part 110, wherein pivotal part 110 as slanted surface 113 disposed at the end adjacent to static part 120, whereas when in idle state surfaces 123 and 113 are substantially tangential. Surfaces 123 and 113 have substantially the same shape and size. When handle 100 is in idle state, static part 120 serves as a stopper to pivotal part 110, which pivotal part 110 is pushed back by a bias such as returning spring 150. FIG. 7 is a top view of door handle assembly 100, being in a closed, idle state. Optionally, Pivotal part 110 is haptically and visually flush with static part 120.

It should be noted that the cylindrical shape of static part 120 and matching pivotal part 110 are given by way of example only, with no limitation. Static part 120 and matching pivotal part 110 can take any shape and from. Preferably, when handle 100 is in idle state, static part 120 and the pivotal part 110 seem to be, haptically and visually, as if made of one piece.

FIG. 8 is a top view of door handle assembly 100, being in an opened state, whereas moveable part 110 is pivotally moved α° to the right. When handle 100 is in open state, an operator uses force to pivotally move pivotal part 110 away from static part 120, overcoming the force of the bias such as returning spring 150. When in idle state, surface 123 of static part 120 serves as a stopper to surface 113 of pivotal part 110, which is pushed back by returning spring 150.

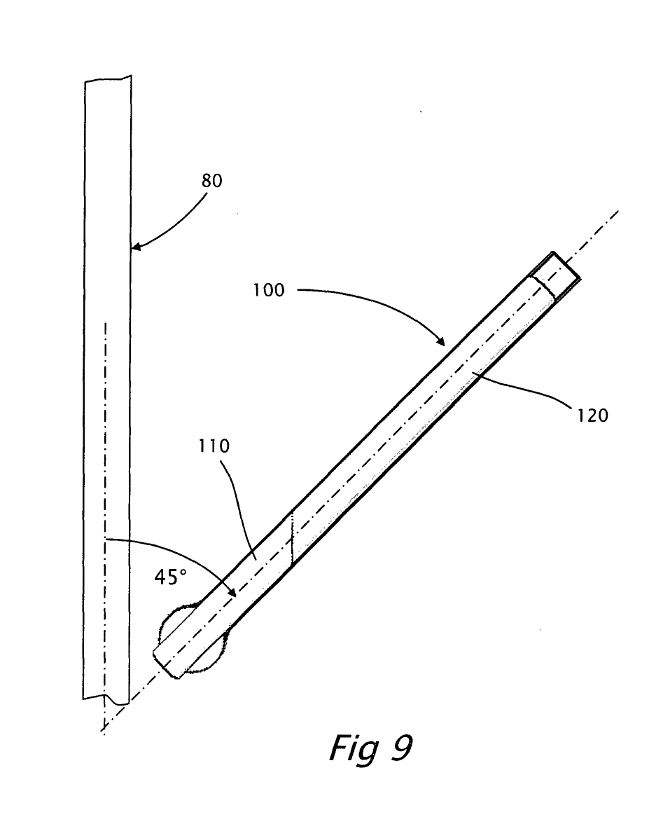

Referring back to FIG. 7, handle assembly 100 is mounted on a door in a vertical orientation and at a distance d from post 80 of the door. Distance d can be discomfortingly small. Hence, the present invention enables mounting at an orientation that is not vertical or horizontal. In the example shown in FIG. 9, which is a top view of door handle assembly 100, mounted on a door in an approximately 45° angle orientation, comfortly away from post 80 of the door.

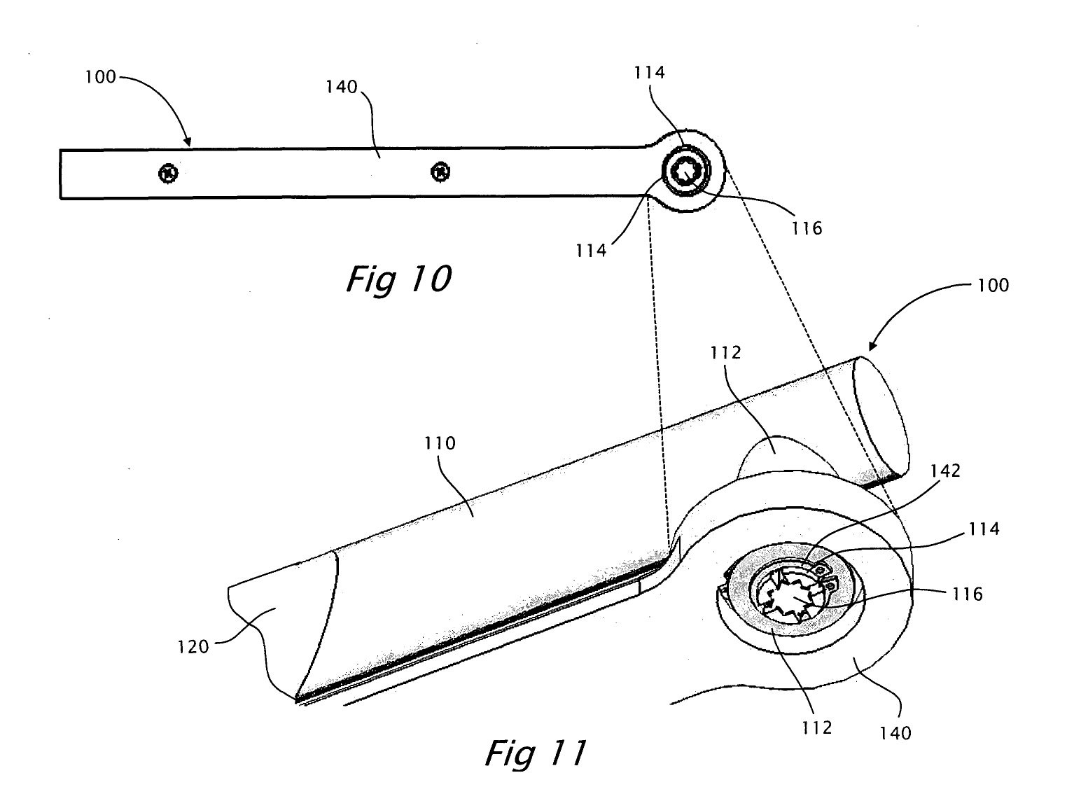

Reference is now also made to FIG. 10, which is a bottom view of the door handle assembly 100 and to FIG. 11, which is an enlarged, bottom perspective view of door handle assembly 100, showing the end portion of the mechanism for attaching to spindle 20. Hollow cavity 116 is formed inside spindle housing 112 symmetrically about axis 111 (see FIG. 6) to fittingly house spindle 20. Hollow cavity 116 has an eight-points star form, facilitating the mounting of handle assembly 100 on standard spindle 20 in 8 directional orientations, rather than just four in prior art.

It should be noted that hollow cavity 116 formed inside spindle housing 112 to fittingly house spindle 20, may have a star form other than an eight-points star form. For example, when hollow cavity 116 has a twelve-points star form, the handle can be mounted in steps of approximately 30°.

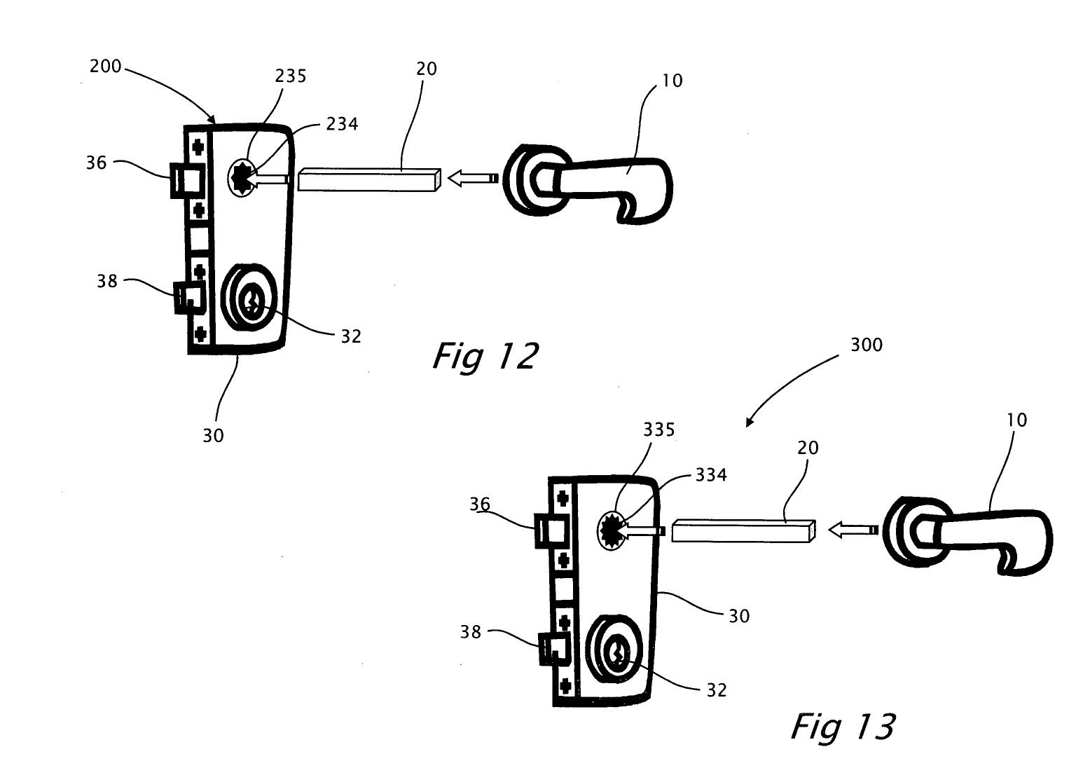

In variations of the present invention, the objective of enabling the mounting a door handle on standard spindle 20 in 8 directional orientations, is achieved by changes made to lock assembly body 30 of lock assembly 50. Reference is now made to FIG. 12, which illustrates an exploded view of handle door assembly 200, according to variations of the present invention. Fitted hollow channel 234, formed inside spindle shaft 235 of lock assembly body 30 of handle door assembly 200, has a cross section shape of a substantially symmetric eight-points star form, rather than a square form, thereby enables mounting spindle 20, and thereby any door handle, in 8 directional orientations, rather than just four. Thereby, spindle 20 (having a square cross section) can be inserted in two orientations, approximately 45° apart. It should be noted that pivotal motion of spindle shaft 235 is operatively engaged with handle cam 36, to move handle cam 36 in or out of lock assembly body 30.

In another example, shown in FIG. 13, which illustrates an exploded view of handle door assembly 300, according to variations of the present invention, fitted hollow channel 334, formed inside spindle shaft 335 of lock assembly body 30 of handle door assembly 300, has a cross section shape of a substantially symmetric twelve-points star form. Thereby, spindle 20 can be inserted in two orientations, approximately 30° apart. It should be noted that pivotal motion of spindle shaft 335 is operatively engaged with handle cam 36, to move handle cam 36 in or out of lock assembly body 30.

The invention being thus described in terms of several embodiments and examples, it will be obvious that the same may be varied in many ways. Such variations are not to be regarded as a departure from the spirit and scope of the invention, and all such modifications as would be obvious to one skilled in the art.

What is claimed is:

1. A door-handle assembly for a door, including a spindle operatively attached to a cam mechanism of a lock mechanism of the door, said spindle having a rotating axis and a substantially square cross section, the door-handle assembly comprising:
(a) a handle comprising:
i. a static part; and
ii. a pivotal part;
(b) a base part;
(c) at least one static mounting part; and
(d) a spindle housing having a first end and an open end,
wherein said base part is securely attached to the door;
wherein said static part is securely attached to the door by said static mounting part;
wherein said pivotal part is securely attached to said first end of said spindle housing, and said open end of said spindle housing is pivotally attached to said base; and
wherein said pivotal part is aligned with said static part.

2. The door-handle assembly of claim 1, wherein said pivotal part, being in idle state, is supported by said static part.

3. The door-handle assembly of claim 1, wherein said static part is securely attached to said base part by said static mounting part;

4. The door-handle assembly of claim 1, wherein said pivotal part is aligned with said static part such that said pivotal part is haptically and visually flush with said static part.

5. The door-handle assembly of claim 1, wherein said spindle housing is pivotally attached to said base part by a spindle attachment assembly.

6. The door-handle assembly of claim 5, wherein said spindle attachment assembly comprises:
(a) a bias; and
(b) a limiter,
wherein said limiter is securely attached onto a fitted groove disposed at said open end of said spindle housing, whereby said spindle housing is pivotally attached to said base part.

7. The door-handle assembly of claim 6, wherein said bias is a returning spring.

8. The door-handle assembly of claim 6, wherein said static part is a stopper of said pivotal part, resisting said bias.

9. The door-handle assembly of claim 6, wherein a stopper of said lock mechanism of the door resists said bias.

10. The door-handle assembly of claim 1, wherein said spindle is operatively attached to said cam mechanism through a hollow channel formed inside said cam mechanism, wherein said hollow channel has a substantially square shape fitted to said substantially square shape of said spindle, and wherein a hollow cavity is formed inside said spindle housing, substantially symmetric about said rotating axis, to fittingly attach a first end section of said spindle.

11. The door-handle assembly of claim 10, wherein said hollow cavity formed inside said spindle housing has an eight-point star cross section.

12. The door-handle assembly of claim 10, wherein said hollow cavity formed inside said spindle housing has a twelve-point star cross section.

13. The door-handle assembly of claim 1, wherein a supporting surface of said static part is a slanted surface disposed at a first end of said static part; wherein said pivotal part has a slanted surface disposed at a first end of said pivotal part; wherein said first end of said static part faces said first end of said pivotal part; and wherein when said pivotal part is reaching said idle state, said slanted surface of said static part is substantially tangential to said slanted surface of said pivotal part.

14. The door-handle assembly of claim 1, wherein said spindle is operatively attached to said cam mechanism through a hollow channel formed in said cam mechanism; wherein said hollow channel has a substantially symmetrical star shape; and wherein said star shaped hollow channel has multiple points P, P being divisible in four (4) such that R=P/4, where R is the number of different orientations, exclusive of symmetrical orientations, in which said spindle can be securely inserted into said hollow channel.
